(19) United States
(12) Patent Application Publication
(10) Pub. No.: US 2005/0279667 A1
(43) Pub. Date: Dec. 22, 2005

(54) Container with cooperative labeling

(76) Inventor: Brian P. Goff, Minneapolis, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 11/155,997

(22) Filed: Jun. 17, 2005

Related U.S. Application Data
(60) Provisional application No. 60/580,937, filed on Jun. 18, 2004.

(51) Int. Cl. B65D 85/00; G09F 3/00

(52) U.S. Cl. 206/459.1; 40/310

(57) ABSTRACT

A container includes a primary label having a removable section provided on the outer surface. A secondary label is provided opposite the primary label and arranged so that an image or lettering is most clearly viewable when the removable section of the primary label is removed.

The present application is based on and claims the benefit of U.S. provisional patent application Ser. No. 60/580,937, filed Jun. 18, 2004, the content of which is hereby incorporated by reference in its entirety.

### BACKGROUND OF THE INVENTION

Label arrangements exist where one or more labels are placed on opposite sides of a container in order to be viewed in a cooperative relationship. For example, some containers are provided with a primary label with a cut-out portion. A secondary label containing an image or lettering is provided opposite the primary label and arranged so that the image or advertising material can be viewed through the cut-out portion, container, and the substance within.

### SUMMARY OF THE INVENTION

The present invention relates to at least one label provided on a container. A primary label having a removable section is provided on the container. A secondary label is provided opposite the primary label and arranged so that an image or lettering is most clearly viewable when the removable section of the primary label is removed.

### BRIEF DESCRIPTION OF THE DRAWINGS

FIG. 1 illustrates a side view of one embodiment of the present invention.

FIG. 2 is a portion of a primary label.

### DETAILED DESCRIPTION

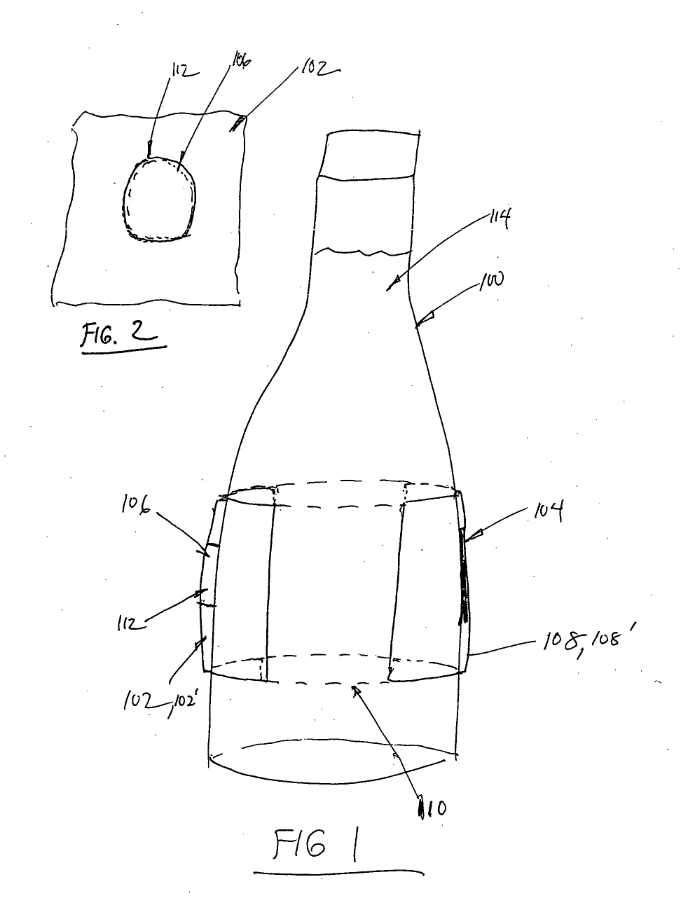

FIG. 1 illustrates a side view of a container in accordance with the present invention. Container 100 is provided with primary label 102, which can be conventionally affixed to container 100. Secondary label 108 having image or lettering 104 is provided opposite primary label 102 and arranged so that image or lettering 104 is obscured by container 100, primary label 102, and/or secondary label 108. FIG. 1 also illustrates an alternate embodiment where label 110 is a single label having a primary portion 102′ and a secondary portion 108′ and is provided around, or substantially around container 100. Label 110 can be conventionally affixed to, clinging to, or slidable relative to container 100 as is known.

Primary label 102, 102′ comprises removable section 106 that can be removed so that an aperture 112 is defined in primary label 102, 102′. Removable section 106 can be a part of or separate with respect to primary label 102, 102′. Image or lettering 104 on secondary label 108, 108′ can then be viewed through aperture 112. In most embodiments, image or lettering 104 is clearly viewable only through aperture 112. It should be noted that primary label 102, 102′ can alternately be merely printing on a surface of the container about removable section 106, 106′.

In a further embodiment, container 100 can be coated with an opaque material or frosting, colored, or its surface altered (roughened, matted, etc.) to obscure image or lettering 104. Container 100 can also be substantially covered by other labels or portions of labels 102, 108 to obscure image or lettering 104.

Aperture 112 (which can be a transparent portion of label 102, 102′) can be aligned with a transparent portion or window of container 100, such as a relatively clear window in an otherwise continuous opaque coating on container 100 as described above.

In yet another embodiment, image or lettering 104 is at least partially distorted to compensate for optical distortion caused by container 100 and/or liquid 114 contained therein such as described in U.S. Pat. No. 4,115,939, which is incorporated herein in its entirety.

Although the present invention has been described with reference to particular embodiments, those skilled in the art will recognize that changes may be made in form and detail without departing from the spirit and scope of the invention.

1. A container comprising:
a primary label placed on a surface of the container, the primary label having a removable section;
a secondary label having an image or lettering and arranged opposite the primary label, wherein the image or lettering is at least partially obscured by primary label until the removable section is removed upon which the image or lettering is seen through walls of the container.

2. The container of claim 1, wherein the image or lettering is most clearly viewable through an aperture defined in the primary label when the removable section is removed.

3. The container of claim 2, wherein the image or lettering is only clearly viewable through the aperture.

4. The container of claim 1, wherein the primary label and the secondary label form portions of a single label.

5. The container of claim 1, wherein the image or lettering is at least partially distorted to compensate for optical distortion of the container.

6. The container of claim 5, wherein the image or lettering is at least partially distorted to compensate for optical distortion of a liquid inside the container.

7. The container of claim 1, and further comprising a coating applied to the container to obscure viewing of the image or lettering.

8. The container of claim 7, wherein the coating defines a window through which the image or lettering is viewable.

9. The container of claim 1, wherein a surface of the container is altered to obscure viewing of the image or lettering.
